(19) United States
(12) Patent Application Publication
(10) Pub. No.: US 2025/0036747 A1
(43) Pub. Date: Jan. 30, 2025

(54) METHOD AND APPARATUS TO DETER DEVICE ATTACKS

(71) Applicant: ARRIS Enterprises LLC, Horsham, PA (US)

(72) Inventors: Xin Qiu, San Diego, CA (US); Rafie Shamsaasef, San Diego, CA (US)

(73) Assignee: ARRIS Enterprises LLC, Horsham, PA (US)

(21) Appl. No.: 18/408,305

(22) Filed: Jan. 9, 2024

Related U.S. Application Data
(60) Provisional application No. 63/437,960, filed on Jan. 9, 2023.

(51) Int. Cl. G06F 21/51; G06F 21/57

(52) U.S. Cl. CPC G06F 21/51; G06F 21/57

(57) ABSTRACT

A system for securing a device executing program instructions is disclosed. The system comprises a first device agent module executing on the device, for monitoring the device and execution of the program instructions and generating monitoring information from the monitoring of the device; a device configuration manager, communicatively coupled to the device for accepting the monitoring information and generating management commands according to the monitoring information; and a second device agent, executing on the device, for accepting and applying the management commands.

### CROSS-REFERENCE TO RELATED APPLICATIONS

This application claims benefit of U.S. Provisional Patent Application No. 63/437,960, entitled “METHOD AND APPARATUS TO DETER DEVICE ATTACKS,” by Xin Qiu et al. filed Jan. 9, 2023, which application is hereby incorporated by reference herein.

### BACKGROUND

### 1. Field

The present disclosure relates to systems and methods for securing computing devices.

### 2. Description of the Related Art

As devices become more widespread and communicably interconnected, the risk of attacks to such devices to compromise the data stored therein or the functioning of the device itself has greatly increased.

### SUMMARY

Minimizing the impact of attacks on digital devices is imperative and requires and integrated plan that secures the device throughout its life cycle. Described herein is a method and related apparatus for providing such security. In one embodiment, the system for securing a device executing program instructions comprises a first device agent module executing on the device, for monitoring the device and execution of the program instructions and generating monitoring information from the monitoring of the device; a device configuration manager, communicatively coupled to the device for accepting the monitoring information and generating management commands according to the monitoring information; and a second device agent, executing on the device, for accepting and applying the management commands. Another embodiment is evidenced by a method of securing a device executing program instructions, comprising: receiving, from a first device agent module executing on the device, monitoring information, the monitoring information generated from the first device agent module monitoring the device and execution of the program instructions; generating, in a device configuration manager, management commands according to the monitoring information; and providing, the management commands to a second device agent operating on the device.

### BRIEF DESCRIPTION OF THE DRAWINGS

Referring now to the drawings in which like reference numbers represent corresponding parts throughout:

FIG. 1 is a diagram illustrating a device and related interfaces;

FIG. 2 is a diagram illustrating the securing of a device throughout its life cycle;

FIG. 3 is diagram presenting a high level workflow of one implementation of a system for post deployment monitoring and control of the device;

FIG. 4 is a diagram further illustrating the Device Configuration Manager and its operations;

FIG. 5 is a diagram depicting exemplary operations that can be used to assure security of the device;

FIG. 6 is a diagram depicting exemplary operations that can be used to generate management commands; and

FIG. 7 illustrates an exemplary computer system that could be used to implement processing elements of the system.

### DESCRIPTION

In the following description, reference is made to the accompanying drawings which form a part hereof, and which is shown, by way of illustration, several embodiments. It is understood that other embodiments may be utilized, and structural changes may be made without departing from the scope of the present disclosure.

### Overview

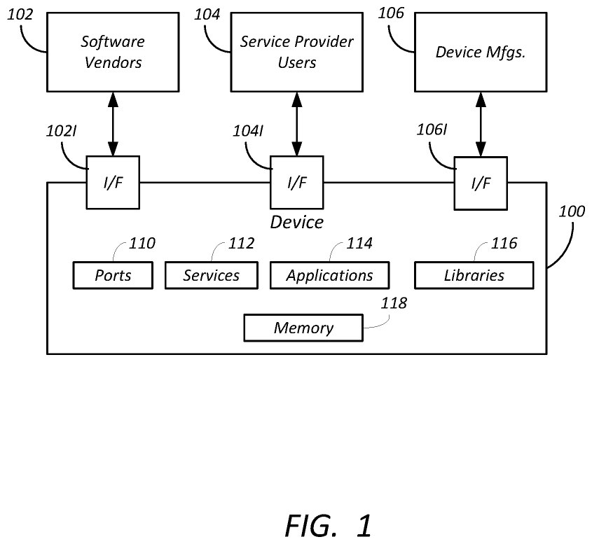

FIG. 1 is a diagram illustrating a device 100 and related interfaces 102I-106I with software vendors 102, service provider users 104, and device manufacturers 106, respectively. The interfaces can be used to transmit to and/or receive data from the software vendors 102, service provider users 104 and device manufacturers 106. Such data can be used to provide services to the device 100, to control the device 100, to monitor the device 100, to provide software updates to the device 100. Although separate interfaces 102I-106I are illustrated, a single interface may be used to communicate with the device 100. Device 100 may include assets such as ports 110, services 112, applications 114, and libraries 116 used to perform device 100 functions.

From a security standpoint, the support provided by software vendors 102, service provider users 104 and device manufacturers 106 is typically uncoordinated or coordinated in an ad hoc manner, thus risking possible inconsistent security strategies to be attempted.

### Securing the Device Throughout its Life Cycle

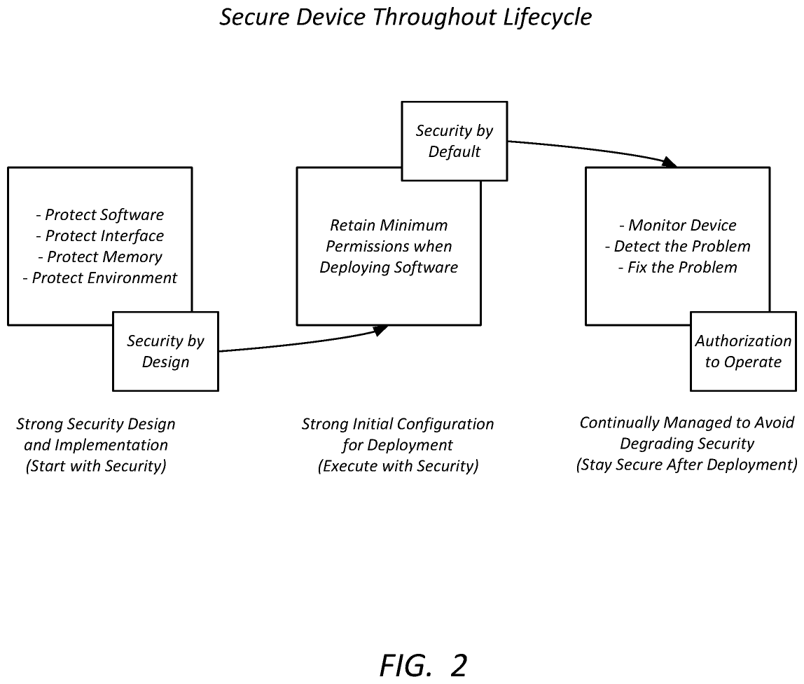

FIG. 2 is a diagram illustrating the securing of a device 100 throughout its life cycle. Deterrence of device 100 attacks throughout the development and life cycle involves implementing robust security measures at various stages to prevent, detect, and respond to potential threats. It requires a comprehensive look at the security of the device 100 and everything else surrounding its usage and deployment. In the provisioning patent, we highlighted a framework and some requirements to create a system from the start to deter device attacks.

### Security by Design

First, the device 100 itself must be designed to be secure (e.g. security by design). This involves designing the device 100 to integrate security considerations into the initial design phase, then following secure coding practices and adhering to established security standards. This is accomplished with a view to protect the software executing on the device 100, the interfaces between the device 100 and other devices as well as internal interfaces within the device 100, and to protect the device memory 118 from unauthorized access and compromise. Further, the environment in which the device 100 is executing (e.g. the platform/environment in which the software is running must be secure, for example, by using scanning tools executing on the platform/environment.

Designed-in security involves activities in both the development and testing stages of the device 100. Factors considered when designing the device 100 and/or software to be secure include product threat modeling and security assessment, and the design of the device 100 includes mechanisms needed for security.

In the development stage, product design, threat modeling, code reviews, dynamic analysis protection and dependency scanning can be utilized as follows:

Product Design: Mechanisms and techniques that can be used to assure secure design include code signing, encryption, and obfuscation as well as a secure code download. Secure debugging and asset protection as well as secure protocols for communication and interfaces may be provided. Keys, certificates and trust models can be applied to such security mechanisms. An anti-debug mechanism should be placed for releases software to prevent attaching a debugger in the runtime to running software.

Product/Threat Modeling: This includes conducting threat modeling sessions to identify potential vulnerabilities and attack vectors, then prioritizing security controls based on the identified threats. Product modeling and security assessment includes modeling the product (device 100 and/or software) and performing security assessments using this modeled product. Such modeling and threat assessment includes modeling and assessing the software stack, external and internal interfaces (including memory and communications interfaces), application and network protocols, hardware security architecture (including system on a chip (SOC) where applicable), and secure memories for sensitive information. For devices which cannot be assured secure, white-box cryptography techniques can be used to protect keys and data. The monitoring agent 302 in the device 100 can also be implemented to actively collect security alarms.

Code Reviews, Static Analysis and Secure Coding: This includes implementing regularly scheduled code reviews with a focus on security. Static code analysis tools can be used to identify and address security vulnerabilities. Secure coding training can also be provided to developers to enhance awareness of common security pitfalls and ensure that the development team is well-versed in secure coding practices.

Dynamic Analysis Protection: Tools such as dynamic executable verification (DEV) tools can be used to sprinkle check points throughout the code and then verify them dynamically at the runtime to prevent dynamic analysis attacks.

Dependency Scanning: This involves the regularly scheduled scanning and updating dependencies, so that known vulnerabilities can be patched. In addition, tools to identify and address security issues in third-party libraries can be implemented. To make the process seamless, tools can be automated and deployed by the developer team.

In the testing stage, dynamic application security testing and penetration and fuzz testing can be utilized as follows:

Dynamic Application Security Testing (DAST): This involves performing dynamic testing to identify vulnerabilities during runtime and simulating real-world attack scenarios to assess device 100 resilience to attacks.

Penetration and Fuzz Testing: This involves conducting regular penetration testing to identify and remediate potential weaknesses. Ethical hackers may be engaged to assess the security posture of the device 100, and fuzz testing may be employed to assess how the device 100 handles unexpected inputs. The testing process can also identify and fix vulnerabilities related to input validation and handling.

### Security by Default

Returning to FIG. 2, when the device 100 is initially deployed and configured for use (e.g. default configuration), the device 100 should enforce minimum permissions required for such deployment and configuration. This is security by default. This secure default configuration minimizes the vulnerability of the device 100 when it can be most vulnerable.

This can be accomplished, for example, by eliminating excessive access to services, memory or instructions, especially with older and potentially vulnerable products and/or protocols. Unused open ports are also disabled until needed, and default accounts and passwords are removed. Software that is unnecessary (likely unused and can be downloaded later if needed) should also be removed. Security during the deployment phase may include a secure booting process, static code signing, and starting the device 100 in a secure configuration.

Secure Configuration: This involves shipping the devices 100 with secure default configurations. Enable users to configure security settings according to their requirements.

Secure Boot: This is accomplished by implementing secure boot processes to ensure the device 100 starts with trusted code. A trusted execution environment (TEE) can be used to create isolated environments for critical operations, protecting sensitive data. If a TEE is not available, use CIPHERKNIGHT or a similar white-box to encode sensitive data and perform crypto operations in the white-box form that hides keys and intermediate data at all times to secure the image. For example, the white box system described in U.S. Pat. No. 11,689,352 (hereby incorporated by reference) may be used. secure enclave all-in-software secure context for keys and assets.

Static Code Signing: This involves signing firmware and software updates with digital signatures to ensure integrity before installation on the device 100. Signatures can be verified during updates to prevent unauthorized code execution.

### Security in Operation

Finally, the device 100 must be continually managed to avoid and prevent the degrading of the security provided by the device 100. This is needed because software executed by the device 100 may be updated or patched over time, new security vulnerabilities are identified and reported, or configurations are modified to allow installation or new software or to support new operational requirements. This involves monitoring the device 100 for security breaches, detecting any such breaches or other problems which may compromise security, configuring the device 100 to minimize the risk of such breaches (e.g. locking memory or preventing some operations), and fixing or ameliorating the security breach.

Elements in assuring security in operation include device 100 management and monitoring, encryption and data protection, and the development and adherence to an incident response plan as follows:

Device Management and Monitoring: This includes implementing centralized device 100 management for monitoring and updates. Also, device 100 behavior is monitored for anomalies that may indicate a security incident. A dashboard is included to visualize device 100 behaviors over time. This is accomplished using the Device Configuration Manager 304 described below.

Encryption and Data Protection: Use encryption to protect data at rest and in transit. Implement secure key management practices to safeguard encryption keys.

Incident Response Plan: Develop and regularly test an incident response plan. Establish protocols for identifying, containing, and mitigating security incidents and present them in a dashboard for tracking and reporting purposes.

Device 100 monitoring and management may be implemented as follows. A device agent such as a watchdog or monitoring agent 302 implemented on the device 100 monitors the device 100 and securely reports information regarding the security of the device 100 (for example, changes to the device 100 configuration from the initial configuration or previous configuration) to an entity (for example, the Device Configuration Manager 304 discussed below). The entity reviews any changes, determines whether to authorize such changes to be committed to the device 100 or to remove the changes from the device 100, and to report the changes to the device 100 and remedial actions to an auditing entity. For example, the current configuration (or changes to the configuration) may be reported and compared to known good configurations to determine if the new configuration puts the device 100 at risk. If the changes put the device 100 at risk, the configuration is denied and/or device is fixed via secure and authenticated messages transmitted to the device 100. This can be accomplished, for example, by putting the device 100 back in one of the known safe configurations, for example, based on an authenticated message from the auditing agency. A second device agent such as a sentry or monitoring agent 306 implemented on the device 100 can be used for this purpose.

### Security at End-of-Life

In addition to assuring security of the device 100 in the design, deployment, and operational stages, security is further enhanced by assuring device 100 security when it is at the end of life. This includes secure decommissioning, and regulatory compliance.

Secure Decommissioning: This involves the implementation of secure procedures for decommissioning and disposing of devices. This includes ensuring data wiping and destruction of cryptographic keys before the device 100 is disposed.

Regulatory Compliance: This involves ensuring compliance with relevant security standards and regulations and remaining informed about evolving security requirements and adjusting practices accordingly.

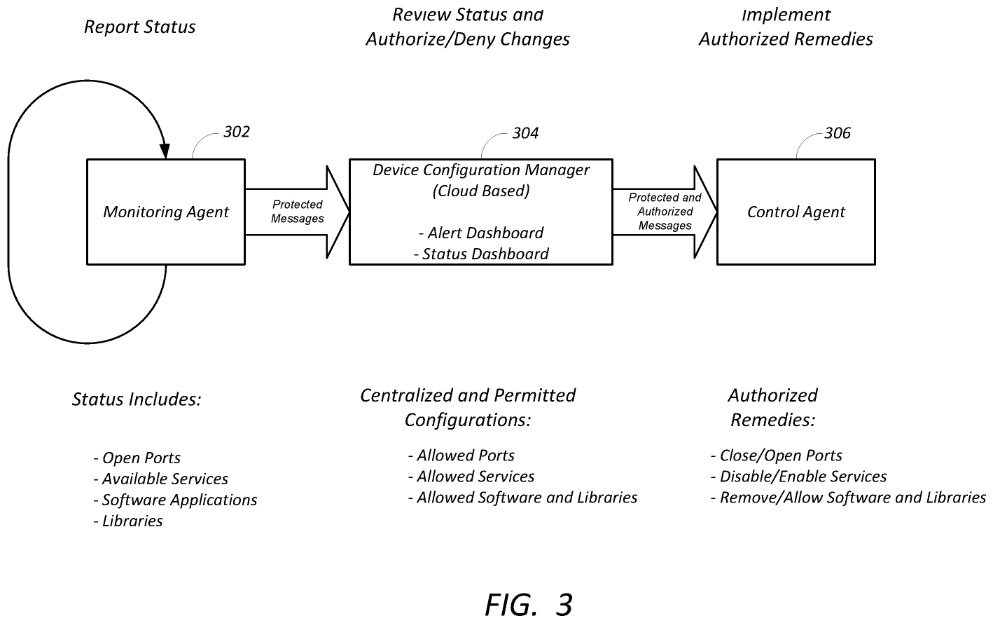

FIG. 3 is diagram presenting a high-level workflow of one implementation of a system for post deployment monitoring and control of the device 100. A monitoring agent 302, implemented on the device 100 reports status in the form of protected messages sent to a Device Configuration Manager 304, which is preferably cloud-based. The reported device 100 status included in the protected messages may include management information such as open device ports 110, available services, software applications 114, libraries 116, and the like. The Device Configuration Manager 304 receives the protected messages, reviews the status and authorizes or rejects changes to the device 100 operation or configuration. Such permitted configurations may be defined at least in part according to the allowed ports, allowed services, allowed software and libraries, as well as other factors. The Device Configuration Manager 304 has a Status Dashboard providing the information regarding the received management information from each device 100, and allows an administrator using the Device Configuration Manager 304 to authorize or refuse such changes. As a result of this input, protected and authorized messages with management commands are provided to a control agent 306, which is used to fix, or repair identified security problems as directed by the administrator. This can include opening or closing ports, disabling, or enabling services, and removing or allowing software and libraries.

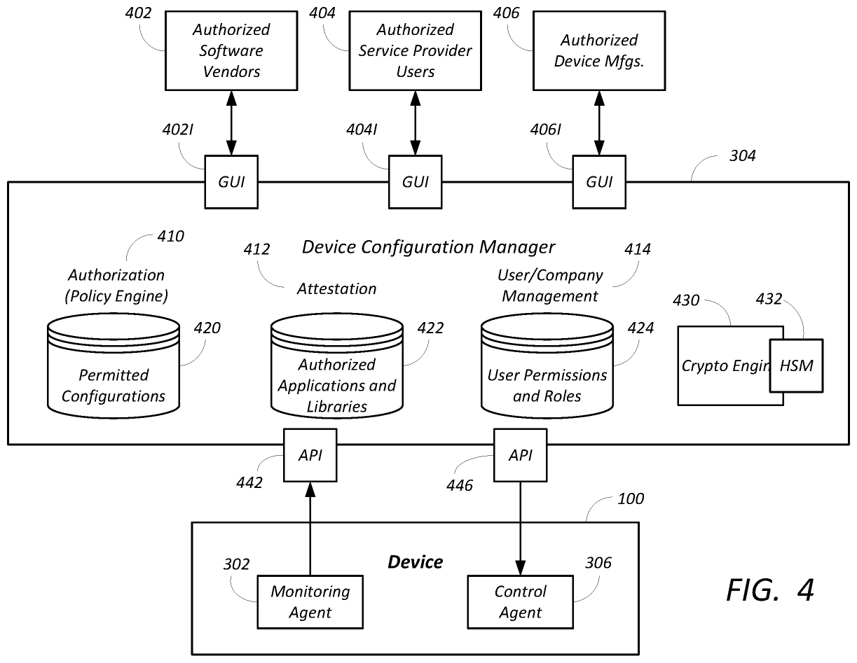

FIG. 4 is a diagram further illustrating the Device Configuration Manager 304 and its operations. Authorized software vendors 402 interface with the Device Configuration Manager 304 via a secure GUI 4021, authorized service provider users 404 likewise interface with the Device Configuration Manager 304 with a similar GUI 4041, and authorized device manufacturers 4061 communicate with GUI 4041.

APIs 442, 446 within the Device Configuration Manager 304 provide interfaces with the monitoring agent 302 and the control agent 306. The APIs are typically two-way interfaces such as RESTful APIs that are based on a request and response mechanism. A policy engine 410 uses stored permitted configurations 420 (e.g. allowed ports, allowed services, and allowed software) in performing management of the device 100. The Device Configuration Manager 304 also has an attestation function 412 which is used to support attestation to validate the integrity of devices 100 in communication with the Device Configuration Manager 304. This is accomplished with the use of a database of authorized applications and libraries 422 which may include hashes of firmware, operating system applications and libraries. The Device Configuration Manager 304 also includes a user/company management function 414 which manages user roles and permissions using a database of user roles and permissions 424 to assure that any users are provided access only to authorized data and management commands. A crypto engine 430, potentially implemented by a hardware security module (HSM) 432, is used by the Device Configuration Manager 304 to generate random numbers, keys, passwords, certificates, and other information as required. Additionally, the Device Configuration Manager 304 may comprise a virtualized dashboard, for displaying the status of the device agents 302, 306.

Both the monitoring agent 302 and control agent 306 apply secure download mechanisms to assure only approved data is downloaded to the device 100, for example, as is described in U.S. Pat. No. 11,811,939, which is here by incorporated by reference herein. This can also be accomplished by attestation mechanism that verifies the integrity of the agent 302 and 306 securely once installed on the device. Such security could be further enhanced by use of node-locking technology in which cryptographic information is node locked so as to be usable only on designated nodes. Exemplary node locking techniques are disclose in U.S. Patent Publication 2023/0269066, entitled “METHOD AND APPARATUS FOR PROVISIONING NODE-LOCKING CONFIDENTIAL DATA”, filed Feb. 9, 2022, U.S. Pat. No. 11,777,732, entitled “TOKEN NODE LOCKING,” issued Oct. 23, 2023 and U.S. Pat. No. 11,625,498, entitled “CLOUD-BASED WHITEBOX NODE LOCKING,” issued Apr. 11, 2023, all of which are hereby incorporated by reference herein.

Status messages sent from the monitoring agent 302 to the Device Configuration Manager 304 via API 442 are authenticated and may be encrypted. This is also true for messages sent from the Device Configuration Manager 304 to the control agent 306 via API 446. Using the User/Company Management function 414 and database 424, a system administrator of the Device Configuration Manager 304 can manage the addition and deletion of authorized users, including software and hardware vendors, and can define user roles and permissions. Such roles and permissions may identify, for example, which users can create an allow list of authorized software, which users can create an allow list of authorized libraries, which users can create an allow list of scripts, and which users can manage ports, services, and other device 100 configurations. User roles are identified as indicated, and access to the Device Configuration Manager 304 is implemented using 2 factor authentication for security purposes.

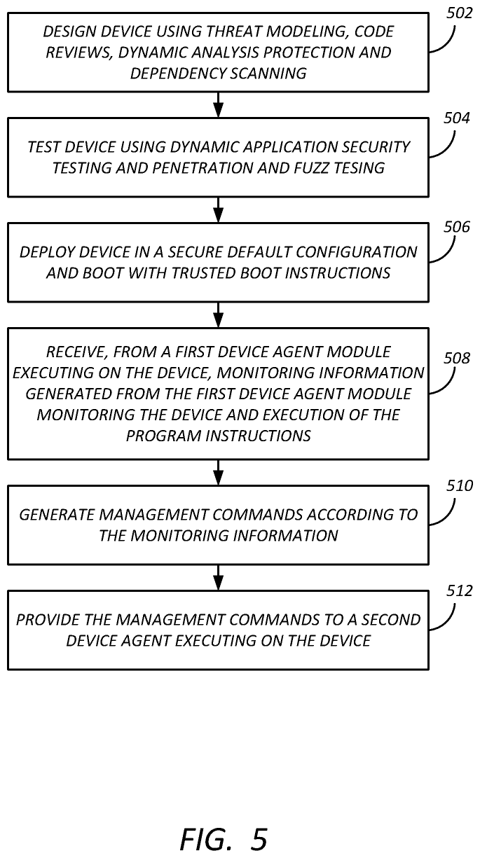

FIG. 5 is a diagram depicting exemplary operations that can be used to assure security of the device 100. Block 502 depicts the design stage, wherein the device 100 is designed using threat modeling, code reviews, dynamic analysis protection and dependency scanning. The device 100 is then tested using dynamic application security testing, and penetration and fuzz testing, as shown in block 504. The device 100 is then deployed in a secure default configuration and booted with trusted boot instructions, as shown in block 506.

In block 508, a Device Configuration Manager 304 receives monitoring information from a first device agent module 302 executed by the device 100. The first device agent 302 generates the monitoring information by monitoring the device 100 and the execution of program instructions and generating the monitoring information therefrom. The monitoring information may include open device ports 110, available device services 112, executing software applications 114, software libraries 116, potential threats, and suspicious abnormalities identified based on runtime patterns, or any combination thereof. In block 510, the Device Configuration Manager 304 generates management commands according to the monitoring information.

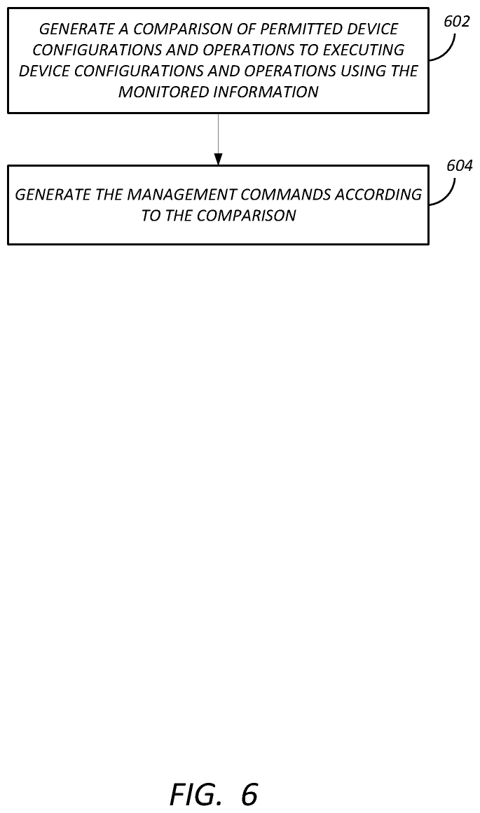

FIG. 6 is a diagram depicting exemplary operations that can be used to generate management commands. Block 602 depicts generating a comparison of permitted device 100 configurations and operations and executing or executed device 100 configurations and operations using the monitored information, and block 604 depicts generating the management commands according to the comparison. The management commands may comprise authorizing the executing device 100 configurations according to the comparison, closing or opening device ports 110, enabling or disabling device services 112, removing or allowing software or libraries to be used on the device 100, and mitigating threats.

### Hardware Environment

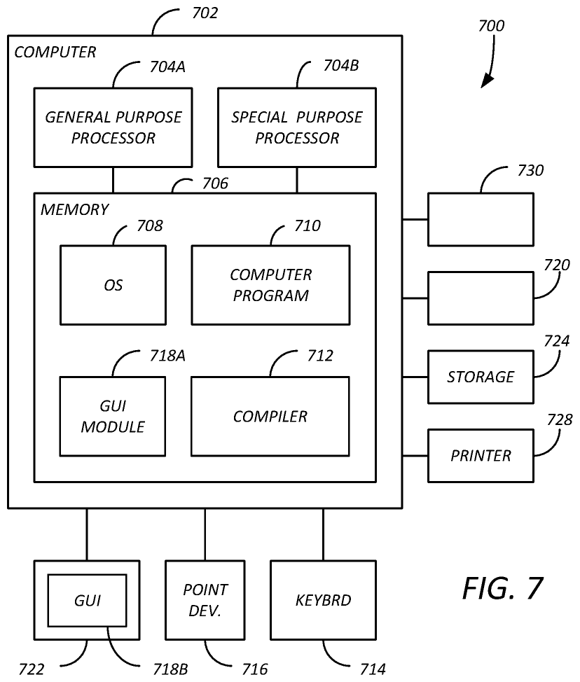

FIG. 7 illustrates an exemplary computer system 800 that could be used to implement processing elements of the above disclosure, including any of the processors executing processor instructions. The computer 702 comprises a processor 704 and a memory, such as random access memory (RAM) 706. The computer 702 is operatively coupled to a display 722, which presents images such as windows to the user on a graphical user interface 718B. The computer 702 may be coupled to other devices, such as a keyboard 714, a mouse device 716, a printer 728, etc. Of course, those skilled in the art will recognize that any combination of the above components, or any number of different components, peripherals, and other devices, may be used with the computer 702.

Generally, the computer 702 operates under control of an operating system 708 stored in the memory 706, and interfaces with the user to accept inputs and commands and to present results through a graphical user interface (GUI) module 718A. Although the GUI module 718B is depicted as a separate module, the instructions performing the GUI functions can be resident or distributed in the operating system 708, the computer program 710, or implemented with special purpose memory and processors. The computer 702 also implements a compiler 712 which allows an application program 710 written in a programming language such as C++ or JAVA, or other language to be translated into processor 704 readable code. After completion, the application 710 accesses and manipulates data stored in the memory 706 of the computer 702 using the relationships and logic that was generated using the compiler 712. The computer 702 also optionally comprises an external communication device such as a modem, satellite link, Ethernet card, or other device for communicating with other computers.

In one embodiment, instructions implementing the operating system 708, the computer program 710, and the compiler 712 are tangibly embodied in a computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of instructions which, when read and executed by the computer 702, cause the computer 702 to perform the operations herein described. Computer program 710 and/or operating instructions may also be tangibly embodied in memory 706 and/or data communications devices 730, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure. By incorporating these ideas into the development and life cycle of devices, we can establish a comprehensive security framework to deter attacks and protect the integrity of the device ecosystem. Where there is a need to protect data outside HSM 432 or TEE, the white box techniques can be used along with obfuscation such as BINARYKNIGHT to provide better protection to the code and data.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A system for securing a device executing program instructions, comprising:
a first device agent module executing on the device, for:
monitoring the device and execution of the program instructions; and
generating monitoring information from the monitoring of the device;
a device configuration manager, communicatively coupled to the device for:
accepting the monitoring information;
generating management commands according to the monitoring information;
a second device agent, executing on the device, for accepting and applying the management commands.

2. The system of claim 1, wherein:
the device configuration manager is communicatively coupled to a database of permitted device configurations and operations, authorized applications and libraries and user permissions and rules.

3. The system of claim 2, wherein the monitoring information includes:
open device ports;
available device services;
executing software applications;
software libraries;
signatures or patterns of potential threats; and
suspicious abnormalities identified based on device runtime patterns.

4. The system of claim 2, wherein generating management commands according to the monitoring information comprises:
generating a comparison of permitted device configurations and operations to executing device configurations and operations using the monitored information; and
generating the management commands according to the comparison.

5. The system of claim 4, wherein the management commands comprise:
authorizing the executing device configurations according to the comparison;
closing or opening device ports;
enabling or disabling device services;
removing or allowing software or libraries to be used on the device; and
mitigating threats.

6. The system of claim 1, wherein the device configuration manager comprises a crypto engine having a hardware security module for generating security information.

7. The system of claim 1, wherein the device configuration manager is cloud-based.

8. The system of claim 1, wherein a lifecycle of the device comprises a deployment stage, and an operational stage wherein:
in the deployment stage:
the device is deployed with a secure default configuration;
the device is booted with trusted boot instructions;
in the operational stage:
the device configuration manager generates management commands according to the monitoring information.

9. The system of claim 8, wherein the management commands are encrypted and signed.

10. The system of claim 8, wherein:
the device comprises a memory;
the lifecycle of the device further comprises an end of life stage; and
the memory of the device is wiped to irreversibly destroy secret information stored in the memory during the end of life stage.

11. A method of securing a device executing program instructions, comprising:
receiving, from a first device agent module executing on the device, monitoring information, the monitoring information generated from the first device agent module monitoring the device and execution of the program instructions;
generating, in a device configuration manager, management commands according to the monitoring information; and
providing, the management commands to a second device agent operating on the device.

12. The method of claim 11, wherein:
the device configuration manager is communicatively coupled to a database of permitted device configurations and operations, authorized applications and libraries and user permissions and rules.

13. The method of claim 12, wherein the monitoring information includes:
open device ports;
available device services;
software applications executing on the device;
software libraries stored by the device; and
signatures or patterns of potential threats; and
suspicious abnormalities identified based on device runtime patterns.

14. The method of claim 12, wherein generating management commands according to the monitoring information comprises:
generating a comparison of permitted device configurations and operations to executing device configurations and operations using the monitored information; and
generating the management commands according to the comparison.

15. The method of claim 14, wherein the management commands comprise:
authorizing the executing device configurations according to the comparison;
closing or opening device ports;
enabling or disabling device services; and
removing or allowing software or libraries.

16. The method of claim 11, wherein:
the device configuration manager further comprises:
a crypto engine having a hardware security module for generating security information; and
a virtualized dashboard, for displaying the status of the device agents.

17. The system of claim 11, wherein the device configuration manager is cloud-based.

18. An apparatus for securing a device executing program instructions, comprising:
a processor;
a memory, communicatively coupled to the processor, the memory storing processing instructions including processor instructions for:
receiving, from a first device agent module executing on device, monitoring information, the monitoring information generated from the first device agent module monitoring the device and execution of the program instructions;
generating, in a device configuration manager, management commands according to the monitoring information;
providing, the management commands to a second device agent operating on the device.

19. The apparatus of claim 18, wherein the processor instructions for generating management commands according to the monitoring information comprise processor instructions for:
generating a comparison of permitted device configurations and operations to executing device configurations and operations using the monitored information; and
generating the management commands according to the comparison.

20. The apparatus of claim 19, wherein the management commands comprise:
authorizing the executing device configurations according to the comparison;
closing or opening ports;
enabling or disabling services;
removing or allowing software or libraries; and
mitigating threats.
